(19) United States
(12) Patent Application Publication
(10) Pub. No.: US 2009/0254676 A1
(43) Pub. Date: Oct. 8, 2009

(54) METHOD FOR TRANSFERRING DATA FRAME END-TO-END USING VIRTUAL SYNCHRONIZATION ON LOCAL AREA NETWORK AND NETWORK DEVICES APPLYING THE SAME

(75) Inventors: Seong-Soon Joo, Daejeon (KR); Young-Sik Chung, Daejeon (KR); Tae-Joon Park, Daejeon (KR); Jin-Young Lee, Seoul (KR); Yoo-Kyoung Lee, Daejeon (KR); Hae-Won Jung, Daejeon (KR); Young-Cheol Bang, Kyungki-do (KR); Moon-Sung Kim, Kyungki-do (KR); Kang-Yong Lee, Kyungki-do (KR); Kyung-Mook Lim, Choongcheongbook-do (KR)

Correspondence Address: LOWE HAUPTMAN HAM & BERNER, LLP, 1700 DIAGONAL ROAD, SUITE 300, ALEXANDRIA, VA, 22314, US

(73) Assignee: Electronics and Telecommunications Research Institute, Daejeon (KR)

(21) Appl. No.: 12/096,758

(22) PCT Filed: Dec. 6, 2006
(86) PCT No.: PCT/KR06/05216

§ 371 Date: Jun. 9, 2008

(30) Foreign Application Priority Data
Dec. 8, 2005 (KR) 10-2005-0119327
Jul. 4, 2006 (KR) 10-2006-0062683

(51) Int. Cl. G06F 15/16

(52) U.S. Cl. 709/236; 709/223

(57) ABSTRACT

A method for transferring data frame end-to-end in a local area network is provided. In the method, a virtual synch frame shaper is loaded on a frame transmission layer structure provided in end stations in transmitting and receiving sides, which transmits data frame passing through a plurality of Ethernet switches in the LAN. Then, slot counters, which are counted through the virtual synch frame shaper, are exchanged between the end stations, and the slot counters are synchronized. Afterward, the transmit time slot is allocated based on the synchronized slot counters for transmitting data frames between the end stations. Finally, data frames are transmitted based on the synchronized slot counters and the allocated transmit time slot.

### TECHNICAL FIELD

The present invention relates to a method for transferring data frame between end stations in a local area network, more particularly, to a method for transferring data frames between end stations, for avoiding congestion of frames with the same priority and for sharing an identical link with different transmission ends by controlling a time of transmitting frames between an end station and an edge switch, and a network device applying the same.

### BACKGROUND ART

A local area network (LAN) is a network designed to share a link between end stations within a corresponding area and to control accessing of links for transferring data. In order to expand a data transferable area or to separate LANs each using a different link access control scheme, the LAN employs a media access control (MAC) bridge to relay or to filter data frames between separated LANs. If data frames are transmitted and received using a plurality of bridges LANs, the bridge queues the data frames if the same path is used.

The LAN is required to provide a service that must transmit related frames from one end station to the other in real time, such as a voice and video service as well as exchanging data which does not require the real time process. For these services, a bridge discriminates a user belonging to a bridged LAN from other users, and separates traffic thereof, queues frames according to a traffic class, selects frames among the queued frames and transmits the selected frames. When a plurality of frames needs to be transmitted simultaneously, the bridge can be overflowed. In this case, the frames may be deleted. Such a phenomenon can occur although the average network utilization rate is low.

As a conventional LAN technology for guaranteeing the real time service quality for transferring data frames from one end station to the other, various conventional methods for reducing frame loss or delay have been introduced. Generally, a method of retransmitting a lost frame or a delayed frame using a supplementary protocol was commonly used. However, the commonly used method cannot satisfy a delay limitation condition in case of a service requiring a real time process.

As another conventional LAN technology for guaranteeing a real-time service quality, a method for assigning a priority to data and processing data having higher priority in advance was introduced. Such a conventional method has an advantage of processing data according to its priority. However, a plurality of frames having the same priority cannot be discriminated. Therefore, the conventional method is effective only when the amount of priority assigned data is small.

According to the simulation results, the method is effective when the priority assigned frames occupy 8% of the entire network resources in case of simple service such as voice. If a large amount of priority assigned frames is transferred in a short time, the frame loss and the transmission delay occur.

As described above, the LAN has been advanced to provide various services such as voice, text and video services, and high quality service such as text and video integrated service. Also, it requires the reference of LAN service quality to be advanced. Service quality scales may include a bandwidth requested by a user in a multiple of a minimum unit bandwidth, for example, about server Kbps to server Gbps, a rate of dropping frames between end stations, a delay of transmitting information between end stations, variation between delays, a security level for transmitting data between end stations, and etc. A service quality requested by a user can be formed of combination of the service quality scales, and the LAN service must provide a customized quality according to a user service.

### DISCLOSURE OF INVENTION

### Technical Problem

The present invention has been made to solve the foregoing problems of the prior art and it is therefore an object of certain embodiments of the present invention to provide a method for transferring a frame between end stations in a local area network, which guarantees to provide customized quality according to each user among service qualities in all range without changing a typical LAN switch, and a network device applying the same.

Another object of the present invention is to provide a method for transferring frames between end stations in a local area network, which enables a switch to output frames without generating congestion frames having the same priority in a typical LAN switch.

### Technical Solution

According to an aspect of the present invention, there is provided a method of transferring frames end-to-end in a LAN (local area network), including the steps of: a) loading a virtual synch frame shaper for transferring frames through virtual synchronization between end stations on a frame transmission layer structure provided in end stations in transmitting and receiving sides, which transmits data frame passing through a plurality of Ethernet switches in the LAN; b) exchanging slot counters, which are counted through the virtual synch frame shaper, between the end stations, and synchronizing the slot counters; c) allocating a transmit time slot based on the synchronized slot counters for transmitting data frames between the end stations; and d) transmitting data frames based on the synchronized slot counters and the allocated transmit time slot.

The step b) may include the steps of: b-1) at the transmitting side end station, transmitting a first slot synch request control frame including own slot counter information to the receiving side end station; b-2) at the transmitting side end station, synchronizing the slot counters based on the slot counter information of the receiving side end station, which is transmitted from the receiving side end station, in response to the first slot synch request control frame; b-3) at the receiving side end station, transmitting a second slot synch request control frame including own slot counter information to the transmitting side end station; and b-4) at the receiving side end station, synchronizing the slot counter based on the slot counter information of the transmitting side end station, which is transmitted from the transmitting side end station, in response to the second slot synch request control frame.

The step c) may include the steps of: c-1) at the transmitting side end station, transmitting a slot allocation request control frame to the receiving side end station for receiving the transmit time slot for transmitting the data frame when transmission of data frame is required: c-2) at the transmitting side end station, receiving information about an allocated transmit time slot, in which a corresponding data frame is not received, from the receiving side end station, corresponding to the slot allocation request control frame; and c-3) at the transmitting side end station, receiving a transmit time slot for transmitting the data frame based on the received transmit time slot information.

The method may further include the step of e) releasing a frame transmission set through the synchronized slot counters between the end stations and the allocated transmit time slot information if the transmitting side end station and the receiving side end station do not generate data frames for a predetermined time.

The method may further include the step of f) releasing a frame transmission set through the synchronized slot counters between the end stations and the allocated transmit time slot information if the transmitting side end station and the receiving side end station do not receive data frames for a predetermined time.

In the embodiment of the present invention, a corresponding frame may be transmitted between the end stations using a control frame including frame type information for identifying contents of a transmitted frame, address information of a virtual synch frame shaper in the transmitting side end station, and type information of the transmitted frame.

The frame information may include at least one of a virtual synch request data for requesting a slot counter of the receiving side end station for synchronizing the slot counters of the transmitting side end station and the receiving side end station, a virtual synch respond data that is a response for the virtual synch request data, a transmit time slot allocation data for transferring data frame in the network, and a transmit time slot allocation response data that is a response to the transmit time slot request data.

The virtual synch frame shaper may be provided in at least one of a system processor and an Ethernet processor in the transmitting side end station and the receiving side end station.

The virtual synch frame shaper may be loaded at the system processor in a software manner, and/or loaded at the Ethernet interface in a software/hardware manner.

According to another aspect of the present invention, there is provided an end station for transferring frames end-to-end in a local area network (LAN), including: a system processor for controlling corresponding operation in a software manner; an Ethernet interface for providing a communication interface in a software/hardware manner to a transmitting side end station and a receiving side end station passing through a plurality of Ethernet switches in a LAN; and a virtual synch frame shaper loading on at least one of the system processor and the Ethernet interface for synchronizing slot counters of the end stations, allocating a transmit time slot for transmitting data frame according to the synchronized slot counter, and transmitting the data frame based on the synchronized slot counter and the allocated transmission time slot.

The virtual synch frame shaper may include: an upper interface for providing a user interface; a lower interface for providing an interface to the Ethernet switch; a slot timer for supplying a slot tick for virtual synchronization through the slot counter and sustaining and controlling the slot counter; a slot manager for sustaining connection information for allocating the transit time slot and setting a data frame transit start point; and a frame shaper for controlling transmission of the data frame according to the synchronized slot counter and the allocated transmit time slot.

The virtual synch frame shaper may synchronize the slot counter based on the slot counter information received from the receiving side end station, and transmit the synchronized slot counter information to the receiving side end station so that the receiving side end station performs the slot synchronization based on the synchronized slot counter.

The virtual synch frame shaper may request the receiving side end station to allocate the transmit time slot, and be allocated with a transmit time slot for transmitting the data frame by receiving information about an allocated transmit time slot of the receiving side end station, in which a corresponding data frame is not received, from the receiving side end station in response of the request.

The virtual synch frame shaper may release a frame transmission set-up through the synchronized slot counters between the end stations and the allocated transmit time slot information if the transmitting side end station and the receiving side end station do not generate data frames for a predetermined time.

The virtual synch frame shaper may release a frame transmission set-up through the synchronized slot counters between the end stations and the allocated transmit time slot information if the transmitting side end station and the receiving side end station do not receive data frames for a predetermined time.

The virtual synch frame shaper may transmit a corresponding frame using a control frame including frame type information for identifying contents of a transmitted frame, address information of a virtual synch frame shaper in the transmitting side end station, and type information of the transmitted frame.

The frame information may include at least one of a virtual synch request data for requesting a slot counter of the receiving side end station for synchronizing the slot counters of the transmitting side end station and the receiving side end station, a virtual synch respond data that is a response for the virtual synch request data, a transmit time slot allocation data for transferring data frame in the network, and a transmit time slot allocation response data that is a response to the transmit time slot request data.

### ADVANTAGEOUS EFFECTS

Certain embodiments of the present invention provide a procedure of sustaining virtual synchronization between end stations in a transmitting and receiving node in a network under a model expressing a rule of generating frames according to characteristics of application services at an end station in order to avoid frame congestion from being generated. The certain embodiments of the present invention also provide an algorithm and a control procedure for controlling a time of starting generation (transmission) of frames in a transmitting side not to overlap the generated or transmitted frames with other frames in a receiving side. The certain embodiments of the present invention, furthermore, provides virtual synch frame shaping that requests to transfer frame properly to a frame generation rule. Therefore, a LAN can be formed to provide a customized end-to-end service quality among service qualities of all ranges including service qualities that were not available at a typical LAN without modifying a switch of a LAN to provide a plurality of transfer qualities.

### BRIEF DESCRIPTION OF THE DRAWINGS

FIG. 1 is a diagram illustrating a physical topology of a bridged local area network (LAN);

FIG. 2 is a diagram illustrating congestion links generated by transferring frames in a LAN formed of Ethernet switches;

FIG. 3 is a LAN that controls a time of transferring frames between end stations in order to share a same transmission link and to avoid the congestion of frames having a same priority for providing a real time service;

FIG. 4 is a diagram for defining a rule of generating frames of application service according to an embodiment of the present invention;

FIG. 5 is a flowchart illustrating a method for transferring frames at an end station through virtual synchronization in a LAN;

FIG. 6 is a flowchart illustrating performing a slot counter synchronization when a virtual synch frame shaper is operated on a network kernel according to an embodiment of the present invention;

FIG. 7 is a flowchart illustrating a step of transferring frames after setting synchronization between end stations when a virtual synch frame shaper is operated on a network kernel as shown in FIG. 6 according to an embodiment of the present invention;

FIG. 8 is a diagram illustrating a structure of a control frame transferred between virtual synch frame shapers according to an embodiment of the present invention;

FIG. 9 is a flowchart illustrating variation of frame information and a slot counter, which are transferred according to a control procedure for allocation a slot for virtual synchronizing and frame shaping in a virtual synch frame shaper according to an embodiment of the present invention;

FIG. 10 is a block diagram illustrating an end station having a virtual synch frame shaper according to an embodiment of the present invention;

FIG. 11 is a block diagram illustrating an edge switch having a virtual synch frame shaper according to another embodiment of the present invention; and

FIG. 12 is a block diagram illustrating a virtual synch frame shaper according to an embodiment of the present invention.

### MODE FOR THE INVENTION

The present invention will now be described more fully hereinafter with reference to the accompanying drawings, in which preferred embodiments of the invention are shown.

Certain embodiments of the present invention provides a method for transferring frames between end stations in a local area network (LAN), which provides a procedure of sustaining virtual synchronization between end stations in a transmitting and receiving node in a network under a model expressing a rule of generating frames according to characteristics of application services at an end station, and controls a time of starting generation (transmission) of frames in a transmitting side not to overlap the generated or transmitted frames with other frames in a receiving side in order to enable switches to output frames without jamming input frames having an identical priority.

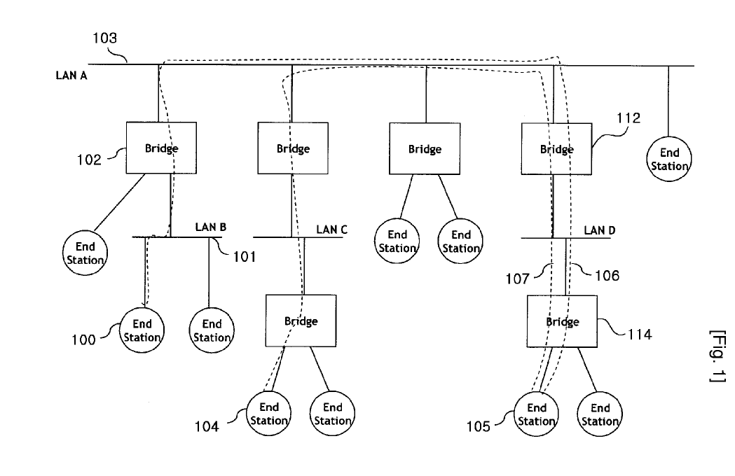

FIG. 1 is a diagram illustrating a physical topology of a bridged local area network (LAN).

As shown in FIG. 1, the bridged LAN 103 is an expanded local area network formed by interconnecting a plurality of single LANs 101 having an end station 100 using media access control bridges 102 which relay or filter data frames. In the present embodiment, such bridges are used to form a virtual LAN satisfying a desired QoS.

The bridges classify traffic through discriminating users of a corresponding bridged LAN from users of the other. The bridges also queue frames according to a traffic class, or selects one of the queued frames and outputs the selected one.

In order to transmit and receive data requiring a real time process such as voice and video data to and from a plurality of end stations 100, 104 and 105 through a bridged LAN, the end stations 100, 104 and 105 may use identical paths 106 and 107. Therefore, the frames may be queued.

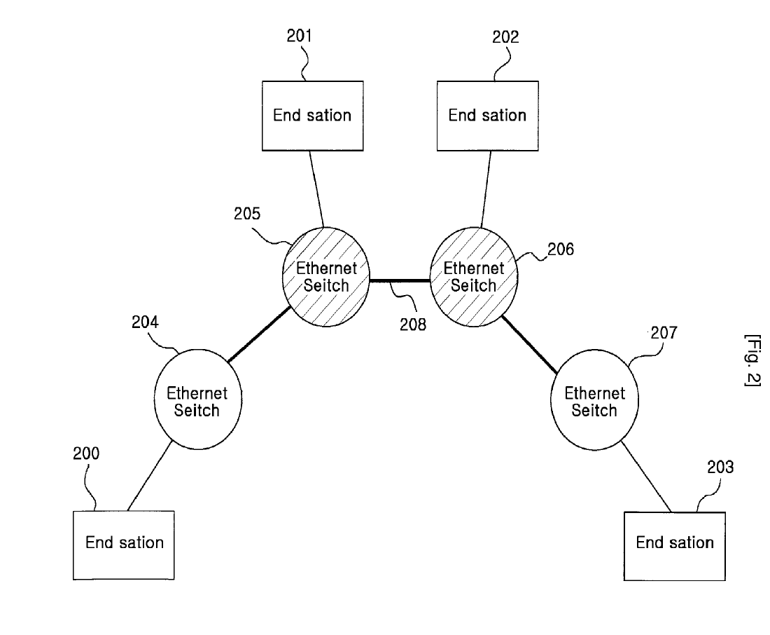

FIG. 2 is a diagram illustrating congestion links generated by transferring frames in a LAN formed of Ethernet switches.

As shown, end stations 200, 201, 202, and 203 are connected to Ethernet switches 204, 205, 206 and 207 for forming a computer network. Accordingly, when end stations 200 and 201 communicate with end stations 202 and 203 at the same time, congestion may be generated at a link 208 between the Ethernet switches 205 and 206. Such a congestion link is generated when a large amount of frames are transferred between two Ethernet switches 205 and 206 at the same time. Herein, the overflowed frames may be deleted. There is a large possibility to generate such a phenomenon although an average network utilization rate is low.

In order to reduce frame loss and transmission delay, various methods have been introduced. Basically, a method of retransmitting data using a supplementary protocol is commonly used. However, such a method cannot satisfy a delay limitation condition of a service requiring a real-time transmission.

In order to reduce the frame loss and the transmission delay, a method for assigning a priority to data and processing the priority assigned data in advance in a network is introduced. Such a method has an advantage of processing data according to its priority. However, a plurality of frames having the same priority cannot be discriminated. Therefore, this method is effective when the amount of priority assigned data is small. According to the simulation results, the method is effective when the priority assigned frames occupy 8% of the entire network resources in case of simple service such as voice. If a large amount of priority assigned frames is transferred in a short time, the frame loss and the transmission delay occur.

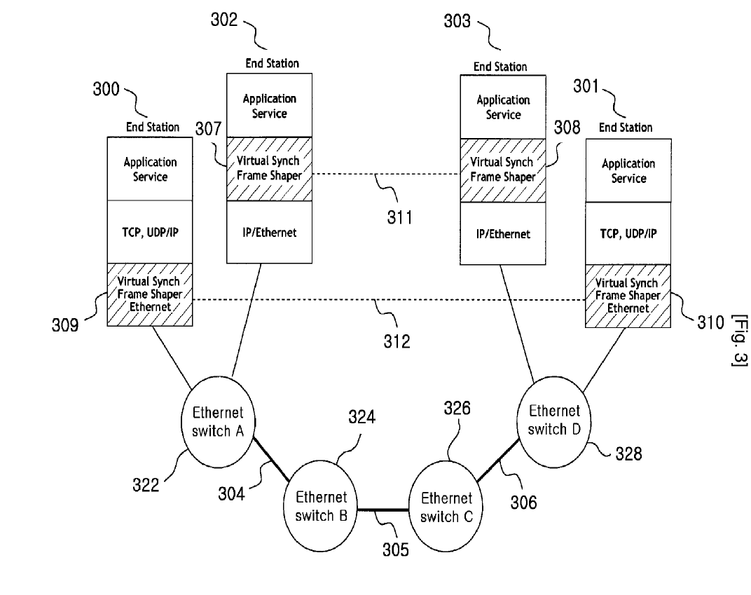

FIG. 3 is a LAN that controls a time of transferring frames between end stations in order to share a same transmission link and to avoid the congestion of frames having a same priority for providing a real time service.

As shown, two end stations 300 and 301 share links 304, 305 and 306 connected through Ethernet switches 322, 324, 326 and 328 with other two end stations 302 and 303 for transferring frames, and frames having the same priority may be queued although they have a higher priority.

In the present embodiment of the present invention, a frame generation rule for generating a frame is defined to be properly to the characteristic of a corresponding application service in order to overcome such a problem. When frames for two services are generated, a time of starting generation of frames for two services is controlled according to the defined frame generation rule not to maximally overlap one frame with the others. Also, a virtual synchronized frame shaper is applied to request others to transfer frames according to the defined frame generation rule. The virtual synchronized frame shaper is an interface kernel of an application service, which can be formed on a network interface kernel as like virtual synch frame shapers 307 and 308 in FIG. 3. Also, they can be formed in an Ethernet frame transmission module, as like virtual synch frame shaper Ethernet 309 and 310.

The virtual synch frame shaper sustains connections of corresponding layers to exchange information for deciding a time of generating frames for services between end stations regardless of Ethernet switches in a LAN.

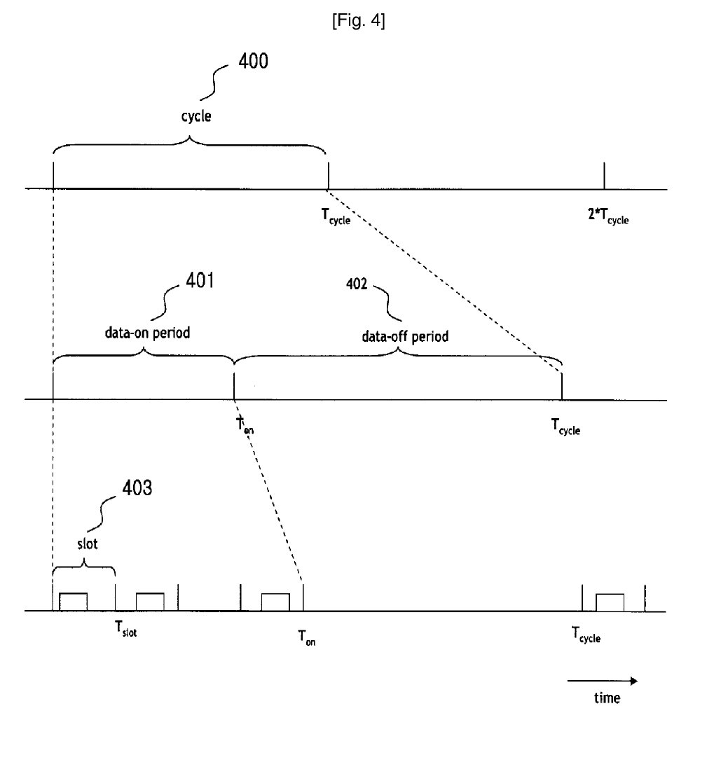

FIG. 4 is a diagram for defining a rule of generating frames of application service according to an embodiment of the present invention.

As shown, the rule of generating frames according to the present embodiment can be formed of the repetition of a data-on period 401 and a data-off period 402, as a method of expressing data generated from an application service according to a user behavior or the characteristic of a service. In the data-on period 401, data to be transferred are cyclically generated. In the data-off period 402, a user does not generate for a predetermined time according to a service characteristic.

Data generated at a corresponding end station is divided into fixed length of frames. For occupying a link for transferring data in discontinuous frames, a predetermined unit time is defined as a slot 403.

The sizes of the data-on period for generating data and the data-off period for not generating data are different according to an application service. In general, the length of each time can be expressed as probability distribution. Accordingly, representative frame generation rules Tₒₙ and T_{off}, which are applicable without disturbing the characteristics of a real service, can be defined as a limited number in the present embodiment.

The virtual synch frame shaper of FIG. 3 transforms data generated from an application service to frames, stores the frames in a buffer, and requests the transferring of frames to a network according to a set frame generation rule.

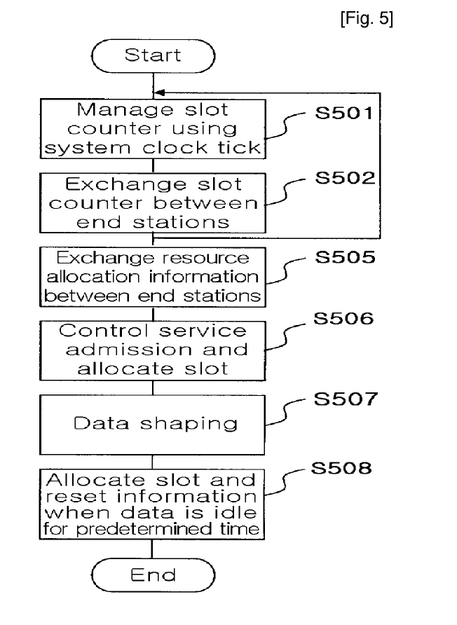

FIG. 5 is a flowchart illustrating a method for transferring frames at an end station through virtual synchronization in a LAN.

As shown, the virtual synchronization is performed for reducing a rate of generating congestion in a network by requesting a transmitting side of each flow to shape a frame so as to maximally prevent frames from being overlapped in all receiving sides in a network. In order to shape frames in a transmitting side in order to avoid congestion from being generated in a network without having information about frame transferring paths of others and without changing the structure of an Ethernet switch or router in a network, a network transfer path and the state thereof must be predicted. The network transfer path and the state thereof are predicted by measuring a delay of a transfer path of each flow between end stations.

In order to predict the path and the state thereof, the end stations in a network are virtually synchronized using a system clock. In more detail, each end station sustains a slot counter at each slot time using a tick of each system time at step S501. In order to obtain a transfer path between a transmitting side and a receiving side, and delay information thereof, all of end stations require the slot counter of other end station, and exchanges slot counter information as a response at step S502. End stations regularly exchange slot counter information by repeatedly performing the steps S501 and S502.

After synchronizing end stations, transmit bandwidth resources are allocated to each of the end stations for transferring data generated by an application service, and the generated data are transferred through the allocated resources. In more detail, a transmitting side end station defines a frame generation rule according to the characteristics of a corresponding application service, and requests the application service with traffic parameters to a receiving side end station at step S505. The receiving side end station sets a transfer path to the transmitting side and a start point of data generation cycle to reduce a probability of overlapping with previously receiving flows while passing the network, and the receiving side end station refuses the application service if it is in a range of generating the congestion of frames at step S506.

When the transmission side end station receives the start point of transferring frames from the receiving side end station, the transmission side end station transforms data generated from the application service to frames, stores them in a buffer, and performs a transferring request to a network according to the defined frame generation rule at step S507. At step S508, the transmitting side end station deletes frame shaping information when the application service interrupts the generation of data for a predetermined time or when the receiving side end station cannot receive frames for a pre-determined time.

As described above, the virtual synchronization between end stations is set, and corresponding frames are transmitted according to the set virtual synchronization.

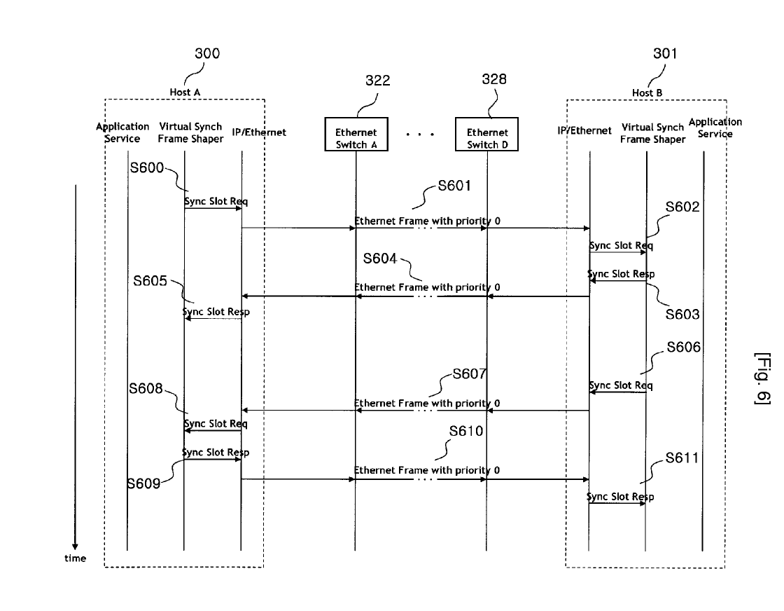

FIG. 6 is a flowchart illustrating performing a slot counter synchronization when a virtual synch frame shaper is operated on a network kernel according to an embodiment of the present invention.

All end stations 300, 301, 302 and 303 in a network transfer an own slot counter and an estimated slot counter of a receiving side end station to a receiving side end station. If no response returns, they correct slot counter information of the receiving side end station.

As shown, at step S600, a virtual synch frame shaper of a host A 300 or 302 in FIG. 3 requests an IP/Ethernet to transfer a slot synch request control frame having the own slot counter information. Then, the IP/Ethernet of the host A 300 forwards the slot synch request control frame as a frame with priority 0 in a network so as to transmit it to a virtually-synchronized receiving side end station 301 or 303 of FIG. 3 through an Ethernet switch A 322 and an Ethernet switch D 328 at step S601.

At step S602, a virtual synch frame shaper of the host B 301, which is a receiving side end station receiving the slot synch request control frame from the host A 300, updates a slot synch table based on a transmitting side address, a transmitting side slot counter and a receiving side slot counter. The virtual synch frame shaper of the host B 301 requests the IP/Ethernet to transmit a slot synch response frame with an own slot counter value and the received transmitting side slot counter information as a response at step S603. The IP/Ethernet of the host B 301 forwards the slot synch response frame as a frame with priority 0 in a network so as to transmit it to the host A 300, which is the virtually synchronized transmitting side end station, through an Ethernet switch D 328 and an Ethernet switch A at step S604.

The virtual synch frame shaper of the host A, which is the transmitting side end station receiving the slot synch response frame, calculates an offset of the slot counter of the transmitting side end station 300 using the slot of the receiving side end station 301, and corrects a slot synch table based on a transmitting side address and a receiving side slot counter offset at step S605.

The virtual synch frame shaper of the host B 301 requests a node having no slot synch information for a predetermined time in a network to transfer a slot synch request control frame with its own slot counter information at step S606. Then, the IP/Ethernet of the host B 301 forwards a transfer request frame of a slot synch request control frame as a frame with priority 0 in a network so as to transmit it to the host A 300, which is the virtually synchronized receiving side end station, through the Ethernet switch D 328 and the Ethernet switch A at step S607.

In case of including the offset information of the transmitting side address, the virtual synch frame shaper of the host A 300, which is the transmitting side receiving the transfer request frame of the slot synch request control frame, corrects the offset by comparing it with a slot counter of the transmitting side end station, or corrects a slot synch table based on the slot counter of the transmitting side end station at step S608. At step S609, the virtual synch frame shaper of the host A 300 requests the IP/Ethernet to transmit the own slot counter value to the host B 301 with the transmitting side end station slot counter information received at the step S608 as the response frame for the transfer request frame of the slot synch request control frame. Accordingly, the IP/Ethernet of the host A 300 forwards the requested response frame as a frame with a priority 0 in a network so as to transmit it to the host B 301, which is the virtually synchronized transmitting side, through the Ethernet switch A 322 and the Ethernet switch D 328 at step S610.

The host B 301, which is the transmitting side end station receiving the response frame transmitted at the step S610, calculates an offset between the slot counter of a transmitting side end station and the slot counter of the receiving side end station, and corrects the slot synch table based on the receiving side address and the receiving slot counter offset at step S611.

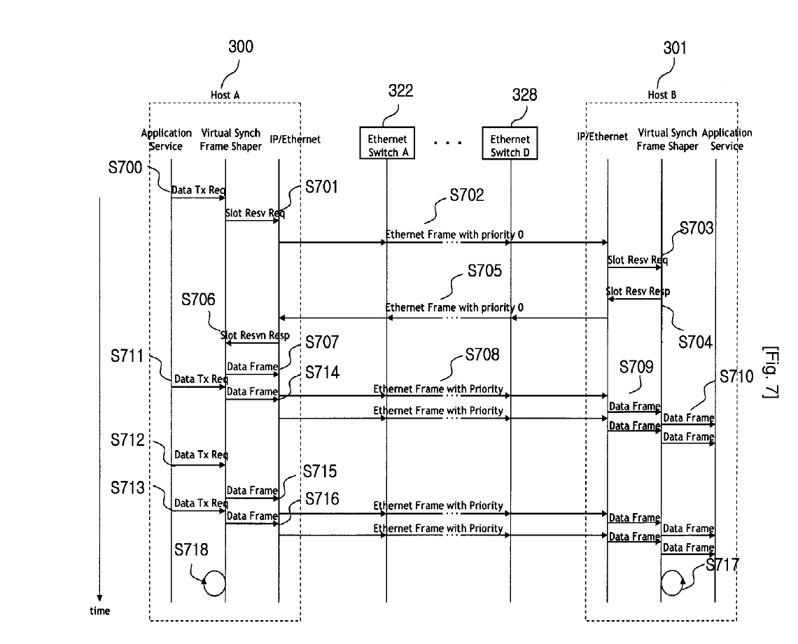

FIG. 7 is a flowchart illustrating a step of transferring frames after setting synchronization between end stations when a virtual synch frame shaper is operated on a network kernel as shown in FIG. 6 according to an embodiment of the present invention.

As shown, at step S700, the host A 300 accesses a virtual synch frame shaper using an application service and requests the virtual synch frame shaper to transfer user data. The virtual synch frame shaper of the host A 300 buffers the use data, creates a slot allocation request control frame with a transmitting side slot counter and a receiving side slot counter estimation value, and transmits the created slot allocation request control frame to the host B 301, which is a receiving side end station, through the Ethernet switch A 322 and the Ethernet switch D 328 at step S701. When the virtual synch frame shaper of the host A 300 receives a frame generation rule with service characteristics reflected, the virtual synch frame shaper of the host A 300 transmits a slot allocation request control frame according to the received frame generation rule. When the virtual synch frame shaper of the host A 300 does not receive a frame generation rule with service characteristics reflected, the virtual synch frame shaper of the host A 300 activates a user data frame monitoring function and transmits a slot allocation request control frame using a default frame generation rule.

Accordingly, the IP/Ethernet of the host A 300 forwards a slot allocation request control frame as a frame with a priority 0 in a network so as to transmit it to the host B 301, which is a virtually synchronized receiving side end station, through the Ethernet switch A 322 and the Ethernet switch D 328 at step S702.

The virtual synch frame shaper of the host B 301, which is the receiving side end station receiving the slot allocation request control frame, corrects a slot counter by comparing the received slot counter value and the own slot synch table at step S703.

The virtual synch frame shaper of the host B 301 changes a time of transferring data within a T cycle time (T_{cycle}) based on a frame generation rule of a new connection and the corrected slot counter as reference at step S704. The virtual synch frame shaper of the host B 301 defines a time of transferring data to prevent frames generated from the new connection from being overlapped with the frames generated by the slot allocation information table having the frame generation rule and the time of transferring data of the previous set connections in the receiving side, and registers the defined data transfer time to the slot allocation information table.

Accordingly, the virtual synch frame shaper of the host B creates a control frame with a receiving side slot counter and a frame generation start offset, and requests the IP/Ethernet to transmit it to the host A 300, which is the transmitting side end station. If frame overlapping exceeds a predetermined threshold value, the virtual frame shaper of the host B 301 transmits data to the transmitting side by changing an offset value to be longer than a T cycle (T_{cycle}).

The IP/Ethernet of the host B 301 forwards the control frame requested to transmit at the step S704 as a frame with a priority 0 so as to transmit it to the host A 300, which is the transmitting side end station, through the Ethernet switch A 322 and the Ethernet switch D 328 at step S705.

In case of receiving a control frame from the host B 301, the virtual synch frame shaper of the host A 300 corrects the slot counter of the host B 301, decides a time of transferring data frame using an offset value of the frame transfer time, and stores the decided frame transfer time in a frame shaper table of the virtual synch frame shaper at step S706. The virtual synch frame shaper of the host A 300 stores buffered user data in a slot buffer, and request an IP/Ethernet to transmit user data at the start point of transferring the frame at step S707. Accordingly, the IP/Ethernet of the host A 300 forwards the request data frame as a frame with a priority 0 in a network so as to transmit it to the host B 301, which is a receiving side end station, through the Ethernet switch A 322 and the Ethernet switch D 328 at step S708.

When the host B receives the data frame from the host A 300, the host B 301 resets a slot counter according to receiving the data frame at step S709, and transfers the received data frame to a user at step S710.

When the host A 300 receives user data transmission requests from users at steps S711, S712 and S713, the host A 300 transfers the corresponding data frame to the host B 301 through a corresponding network through performing a priority queue process at a corresponding time according to the initially defined frame generation rule at steps S714, S715 and S716.

If the host B 301, which is a receiving side end station, and the host A 300, which is a transmitting side end station, do not receive or transmit data frames for a pre-determined time, the host B 301 and the host A 300 release the connection therebetween and delete the connection information thereof from the slot allocation table at steps S717 and S718.

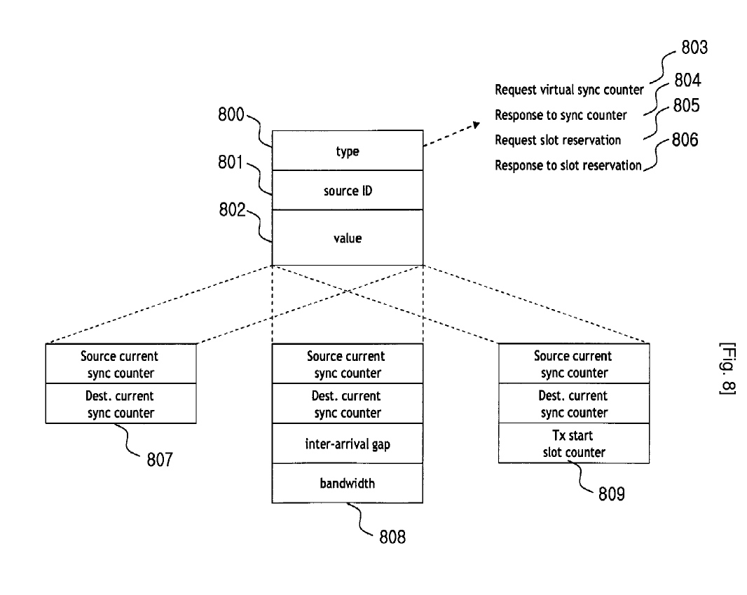

FIG. 8 is a diagram illustrating a structure of a control frame transferred between virtual synch frame shapers according to an embodiment of the present invention.

As shown, the control frame is not transferred to a user. It is only transmitted to the virtual synch frame shapers. The control frame includes a type field 801 for classifying contents of a control frame, a source ID field 801 for the address of a frame shaper in a transmitting side, and a value field 802 for information corresponding to the control frame type.

The type field 800 includes information about a virtual sync counter request 803 for requesting a slot counter of a receiving side in order to synch slot counters in the receiving and transmitting sides, a sync counter response 804, which is a response for the request of virtual sync counter 803, a slot reservation request 805 for requesting frame shaper information for transferring frames within a network, and a slot reservation response 806 which is a response for the request slot reservation 805.

The virtual sync counter request 803 and response 804 are performed through transferring data using a transmitting side slot counter and a receiving side slot counter 807. The slot reservation request 805 is performed through transferring data based on Tₒₙ and T_{off} denoting a frame generation rule, and a bandwidth as information 808. The slot reservation response 806 is performed through transferring a transmitting side slot counter, a receiving slot counter, and an offset counter value of a frame shaping starting time 809.

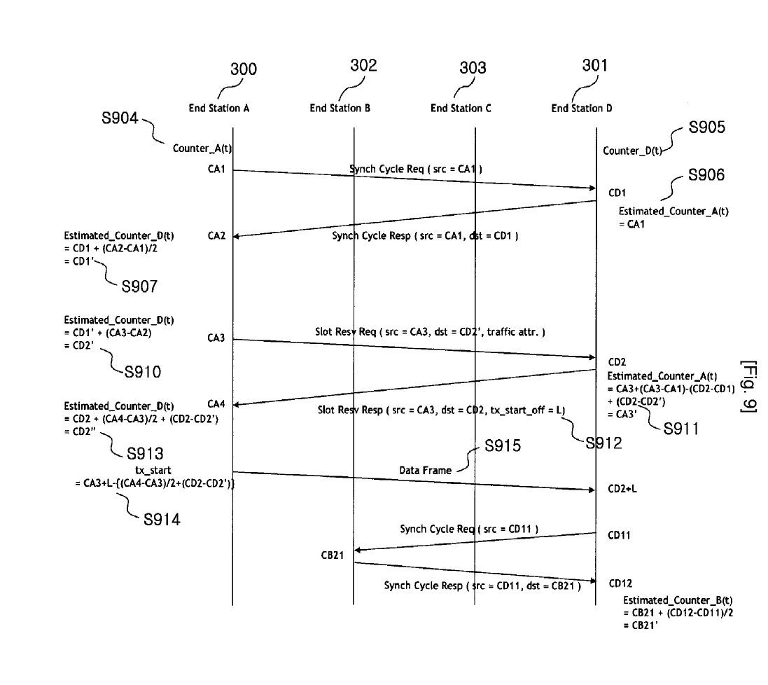

FIG. 9 is a flowchart illustrating variation of frame information and a slot counter, which are transferred according to a control procedure for allocation a slot for virtual synchronizing and frame shaping in a virtual synch frame shaper according to an embodiment of the present invention.

As shown, an end station A 300 performs virtual synchronization with an end station D 301 and slot allocation thereof, and an end station D 303 performs virtual synchronization with an end station B 301 and slot allocation thereof.

The end station A 300 and the end station D 301 have own slot counters CA1 and CD1 at steps S904 and S905, and estimates opponents slot counter information CD1 and CA1 based on slot counter information transmitted from the opponents at steps S906 and S907.

Then, the end station A 300 calculates a slot counter of a receiving side end station D 301, which is estimated when frame shaping information is required to the end station D 301 at a time CA3 for transferring user data, based on the estimation slot counter information CD1 of the end station D 301 at step S910.

The end station D 301 synchronizes the slot counter of the end station A 300, which is the transmitting side, at step S911. Then, the end station D 301 decides a frame generation starting time offset to minimize new frames overlapping with frames of previous connections based on the delay between the transmitting side and the receiving side, and responses to the transmitting side at step S912.

The end station A 300 corrects a slot counter of an end station D 301 for the response of the end station D 301 at step S913, a frame shaping staring point is calculated as a slot counter of the end station A 300 at step S914, and data frame shaping starts at step S915.

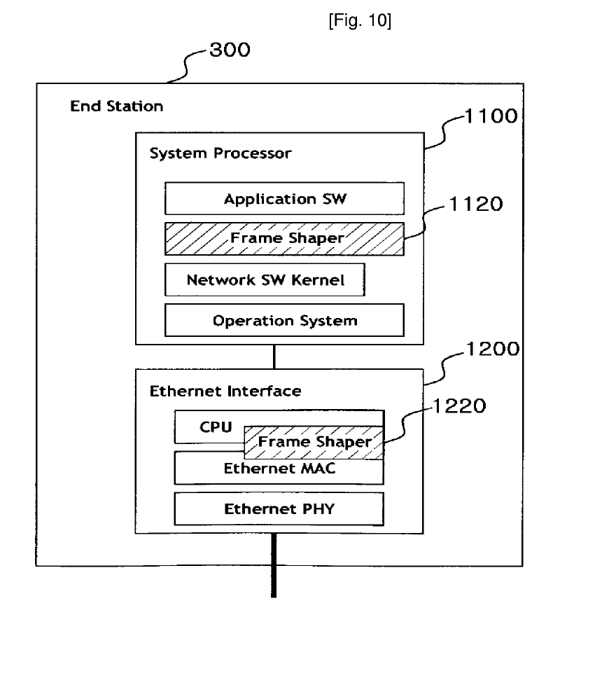

FIG. 10 is a block diagram illustrating an end station having a virtual synch frame shaper according to an embodiment of the present invention.

As shown, the virtual synch frame shaper can be applied to an end station 300 including a system processor 1100 for controlling corresponding operation of the end station 300 in software manner, and an Ethernet interface 1200 for providing a communication interface between transmitting and receiving end stations passing through a plurality of Ethernet switches in a local area network in software and hardware manner. The virtual synch frame shaper can be embodied in software manner as like a frame shaper 1120, or in software and hardware logic as like a frame shaper 1220 in FIG. 10.

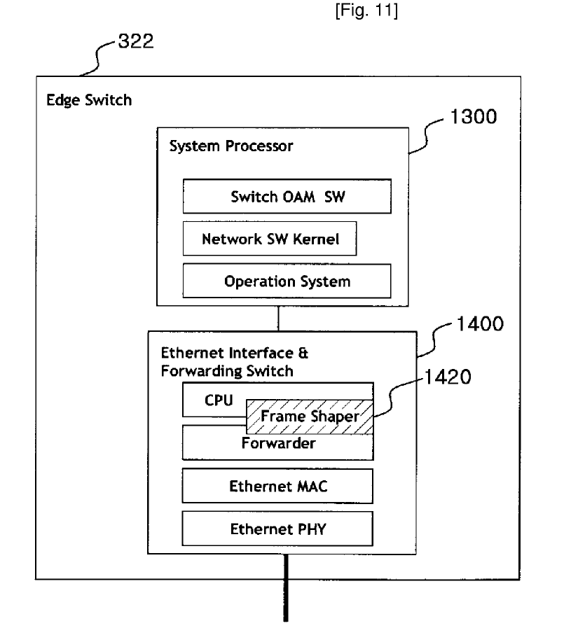

FIG. 11 is a block diagram illustrating an edge switch having a virtual synch frame shaper according to another embodiment of the present invention.

As shown, the virtual synch frame shaper can be applied to an edge switch 322 including a system processor 1300, and an Ethernet interface/forwarding switch 1400. Herein, the virtual synch frame shaper can be embodied in software and hardware manner as like a frame shaper 1420.

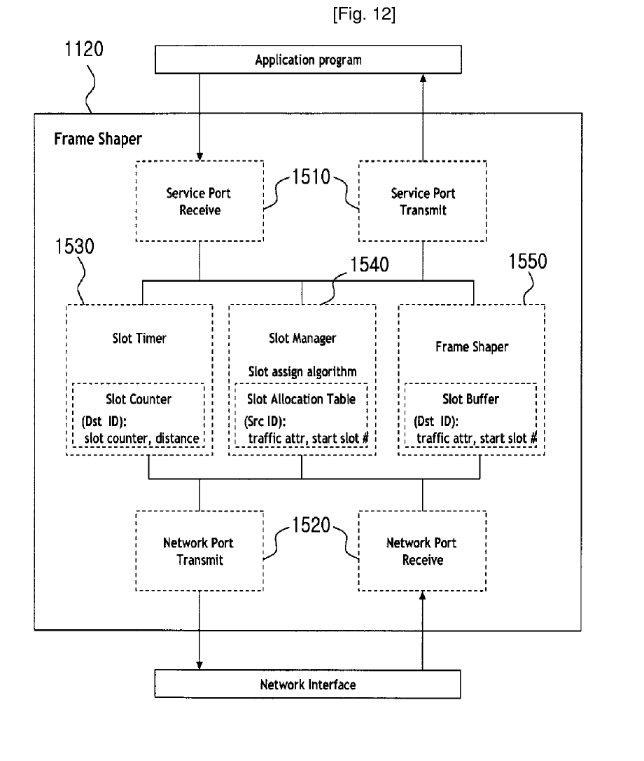

FIG. 12 is a block diagram illustrating a virtual synch frame shaper according to an embodiment of the present invention.

As shown, the virtual synch frame shaper 1120 includes an upper interface 1510 in a user program, which changes according to whether it is formed in software manner or in hardware manner, and a lower interface 1520 in an Ethernet network. The virtual synch frame shaper 1120 includes a slot timer 1530 for providing a slot tick for virtual synchronization, and controlling and sustaining a slot counter table, a slot manager 1540 for sustaining connection information for allocating slots and performing a slot allocation algorithm for setting a frame shaping starting point, and a frame shaper 1550 for managing a buffer for frame shaping and controlling transmission of frames at a corresponding slot.

As described above, the certain embodiments of the present invention provide a procedure of sustaining virtual synchronization between end stations in a transmitting and receiving node in a network under a model expressing a rule of generating frames according to characteristics of application services at an end station in order to avoid frame congestion from being generated. The certain embodiments of the present invention also provide an algorithm and a control procedure for controlling a time of starting generation (transmission) of frames in a transmitting side not to overlap the generated or transmitted frames with other frames in a receiving side. The certain embodiments of the present invention, furthermore, provides virtual synch frame shaping that requests to transfer frame properly to a frame generation rule. Therefore, a LAN can be formed to provide a customized end-to-end service quality among service qualities of all ranges including service qualities that were not available to provided in a typical LAN without modifying a switch of a LAN to provide a plurality of transfer qualities.

While the present invention has been described with reference to the particular illustrative embodiments and the accompanying drawings, it is not to be limited thereto but will be defined by the appended claims. It is to be appreciated that those skilled in the art can substitute, change or modify the embodiments into various forms without departing from the scope and spirit of the present invention.

1. A method of transferring frames end-to-end in a LAN (local area network), comprising the steps of:
a) loading a virtual synch frame shaper for transferring frames through virtual synchronization between end stations on a frame transmission layer structure provided in end stations in transmitting and receiving sides, which transmits data frame passing through a plurality of Ethernet switches in the LAN;
b) exchanging slot counters, which are counted through the virtual synch frame shaper, between the end stations, and synchronizing the slot counters;
c) allocating a transmit time slot based on the synchronized slot counters for transmitting data frames between the end stations; and
d) transmitting data frames based on the synchronized slot counters and the allocated transmit time slot.

2. The method according to claim 1, wherein the step b) includes the steps of:
b-1) at the transmitting side end station, transmitting a first slot synch request control frame including own slot counter information to the receiving side end station;
b-2) at the transmitting side end station, synchronizing the slot counters based on the slot counter information of the receiving side end station, which is transmitted from the receiving side end station, in response to the first slot synch request control frame;
b-3) at the receiving side end station, transmitting a second slot synch request control frame including own slot counter information to the transmitting side end station; and
b-4) at the receiving side end station, synchronizing the slot counter based on the slot counter information of the transmitting side end station, which is transmitted from the transmitting side end station, in response to the second slot synch request control frame.

3. The method according to claim 1, wherein the step c) includes the steps of:
c-1) at the transmitting side end station, transmitting a slot allocation request control frame to the receiving side end station for receiving the transmit time slot for transmitting the data frame when transmission of data frame is required;
c-2) at the transmitting side end station, receiving information about an allocated transmit time slot, in which a corresponding data frame is not received, from the receiving side end station, corresponding to the slot allocation request control frame; and
c-3) at the transmitting side end station, receiving a transmit time slot for transmitting the data frame based on the received transmit time slot information.

4. The method according to claim 1, further comprising the step of e) releasing a frame transmission set through the synchronized slot counters between the end stations and the allocated transmit time slot information if the transmitting side end station and the receiving side end station do not generate data frames for a predetermined time.

5. The method according to claim 1, further comprising the step of f) releasing a frame transmission set through the synchronized slot counters between the end stations and the allocated transmit time slot information if the transmitting side end station and the receiving side end station do not receive data frames for a predetermined time.

6. The method according to claim 1, wherein a corresponding frame is transmitted between the end stations using a control frame including frame type information for identifying contents of a transmitted frame, address information of a virtual synch frame shaper in the transmitting side end station, and type information of the transmitted frame.

7. The method according to claim 6, wherein the frame information includes at least one of a virtual synch request data for requesting a slot counter of the receiving side end station for synchronizing the slot counters of the transmitting side end station and the receiving side end station, a virtual synch respond data that is a response for the virtual synch request data, a transmit time slot allocation data for transferring data frame in the network, and a transmit time slot allocation response data that is a response to the transmit time slot request data.

8. The method according to claim 1, wherein the virtual synch frame shaper is provided in at least one of a system processor and an Ethernet processor in the transmitting side end station and the receiving side end station.

9. The method according to claim 8, wherein the virtual synch frame shaper is loaded at the system processor in a software manner, and/or loaded at the Ethernet interface in a software/hardware manner.

10. An end station for transferring frames end-to-end in a local area network (LAN), comprising:
a system processor for controlling corresponding operation in a software manner;
an Ethernet interface for providing a communication interface in a software/hardware manner to a transmitting side end station and a receiving side end station passing through a plurality of Ethernet switches in a LAN; and
a virtual synch frame shaper loading on at least one of the system processor and the Ethernet interface for synchronizing slot counters of the end stations, allocating a transmit time slot for transmitting data frame according to the synchronized slot counter, and transmitting the data frame based on the synchronized slot counter and the allocated transmission time slot.

11. The end station according to claim 10, wherein the virtual synch frame shaper includes:
an upper interface for providing a user interface;
a lower interface for providing an interface to the Ethernet switch;
a slot timer for supplying a slot tick for virtual synchronization through the slot counter and sustaining and controlling the slot counter;
a slot manager for sustaining connection information for allocating the transit time slot and setting a data frame transit start point; and
a frame shaper for controlling transmission of the data frame according to the synchronized slot counter and the allocated transmit time slot.

12. The end station according to claim 11, wherein the virtual synch frame shaper synchronizes the slot counter based on the slot counter information received from the receiving side end station, and transmit the synchronized slot counter information to the receiving side end station so that the receiving side end station performs the slot synchronization based on the synchronized slot counter.

13. The end station according to claim 11, wherein the virtual synch frame shaper requests the receiving side end station to allocate the transmit time slot, and is allocated with a transmit time slot for transmitting the data frame by receiving information about an allocated transmit time slot of the receiving side end station, in which a corresponding data frame is not received, from the receiving side end station in response of the request.

14. The end station according to claim 10, wherein the virtual synch frame shaper releases a frame transmission set-up through the synchronized slot counters between the end stations and the allocated transmit time slot information if the transmitting side end station and the receiving side end station do not generate data frames for a predetermined time.

15. The end station according to claim 10, wherein the virtual synch frame shaper releases a frame transmission set-up through the synchronized slot counters between the end stations and the allocated transmit time slot information if the transmitting side end station and the receiving side end station do not receive data frames for a predetermined time.

16. The end station according to claim 10, wherein the virtual synch frame shaper transmits a corresponding frame using a control frame including frame type information for identifying contents of a transmitted frame, address information of a virtual synch frame shaper in the transmitting side end station, and type information of the transmitted frame.

17. The end station according to claim 16, wherein the frame information includes at least one of a virtual synch request data for requesting a slot counter of the receiving side end station for synchronizing the slot counters of the transmitting side end station and the receiving side end station, a virtual synch respond data that is a response for the virtual synch request data, a transmit time slot allocation data for transferring data frame in the network, and a transmit time slot allocation response data that is a response to the transmit time slot request data.
